(19) United States
(12) Patent Application Publication
(10) Pub. No.: US 2010/0035226 A1
(43) Pub. Date: Feb. 11, 2010

(54) COMPUTERIZED EDUCATION DEVICE, MULTIMEDIA PRODUCTION DEVICE AND ASSOCIATED METHODS TO SUPPORT DISTANCE LEARNING

(75) Inventors: Tzu-Yin LU, Kaohsiung City (TW); Chia-Lin Lu, Kaohsiung City (TW); Ya-Pei Chen, Kaohsiung City (TW); Shu-Ching Wang, Kaohsiung City (TW); Yu-Cheng Hsiao, Kaohsiung City (TW); Pei-Ching Cheng, Kaohsiung City (TW); Ho-Yun Shih, Kaohsiung City (TW); Tai-Ling Li, Kaohsiung City (TW); Kuei-Yin Lin, Kaohsiung City (TW); Yann-Horng Chen, Kaohsiung City (TW); Cheng-Hui Chiang, Kaohsiung City (TW)

Correspondence Address: RABIN & Berdo, PC, 1101 14TH STREET, NW, SUITE 500, WASHINGTON, DC, 20005, US

(73) Assignee: BAIS Education & Technology Co., Ltd., Kaohsiung City (TW)

(21) Appl. No.: 12/535,992

(22) Filed: Aug. 5, 2009

(30) Foreign Application Priority Data
Aug. 5, 2008 (TW) 097129741
Aug. 21, 2008 (TW) 097131988
Dec. 1, 2008 (TW) 097146567
Apr. 3, 2009 (TW) 098111193

(51) Int. Cl. G09B 7/00

(52) U.S. Cl. 434/350

(57) ABSTRACT

A computerized education device, a multimedia production device and associated methods in accordance with the present invention provide students with an adaptive and proactive interaction learning environment. The computerized education device allows students to log in and take tests and comprises a computer-based learning platform, a content database, a student database and a processor. The multimedia production device has multiple-user and multiple-tasking capabilities to produce multimedia materials and comprises a managing server and multiple stations. A FLASH component conversion method generates a Flash component without expensive creation work and comprises acts of retrieving content, sampling, generating a small web format file, generating a data model and generating a FLASH quiz. The interacting method changes difficulty of content based on responses of students and comprises acts of qualifying, entertaining and compiling statistics.

### FIELD OF THE INVENTION

The present invention relates to a computerized education device, multimedia production device and associated methods to support distance learning that provide students with an adaptive and proactive interactive learning environment.

### BACKGROUND OF THE INVENTION

The process of educational instruction has changed greatly from conventional teaching techniques in recent years. The conventional teaching techniques involve a teacher presenting concepts to students in a non-interactive way. Often, textbooks or other printed materials are provided to students in anticipation that the students will study the printed material before the teacher presents and explains the material in class. Conventional education techniques, even today, are still taught principally with words, and textbooks and speech as primary mediums of communication in a classroom. Therefore, distance learning has become a desirable option for education, which conforms to time and geographic constraints of teachers and students. Use of networks including local and wide area networks such as the internet and local area networks (LANs) has made this possible.

Use of networks allows students to study at anytime and any place.

Advancement of animation technology, particularly Macromedia's Flash, has created interactive animation of images. However, Flash was designed as a professional tool for artists and animators to create professional internet animations. Professional Flash animators are expensive and difficult to find. Most teachers are not sufficiently educated to create dynamic images using Macromedia's Flash. Therefore, there is a need for a web-based education device that requires an efficient method to build an effective distant learning device without having to employ highly skilled and trained specialists.

To overcome Flash's static content limitation, a need for a web-based education device that allows Flash content to be changed dynamically based on responses of students is required.

### SUMMARY OF THE INVENTION

The present invention has multiple objectives. The primary objective is to provide a computerized education device with a learning platform that allows a student to log in and take tests.

The secondary objective is to provide a computerized multimedia production device that has multiple-user and multiple-tasking capabilities to produce multimedia materials.

The third objective is to provide a Flash component conversion method that generates a Flash component without expensive creation work.

The fourth objective is to provide a dynamic interactive method that allows changing difficulty of content based on responses of students.

The computerized education device, multimedia production device and associated methods in accordance with the present invention provide students with an adaptive and proactive interactive learning environment. The computerized education device allows a student to log in and take tests and comprises a computer-based learning platform, a content database, a student database and a processor. The multimedia producing device has multiple-user and multiple-tasking capabilities to produce multimedia materials and comprises a managing server and multiple stations. The FLASH component conversion method makes a Flash component without expensive creation work and comprises acts of retrieving content, sampling, generating a small web format file, generating a data model and generating a FLASH quiz. The interacting method changes difficulty of content based on responses of students and comprises acts of qualifying, entertaining and compiling statistics.

### BRIEF DESCRIPTIONS OF THE DRAWINGS

FIG. 1 is a functional block diagram of a computerized education device in accordance with the present invention;

FIG. 2 is a flow diagram of a Flash component conversion method in accordance with the present invention;

FIG. 3 is a flow diagram of an interacting method in accordance with the present invention;

FIG. 4 is a functional block diagram of a multimedia production system in accordance with the present invention; and

FIG. 5 is a flow diagram of a content decomposing method in accordance with the present invention.

### DETAILED DESCRIPTION OF THE PRESENT INVENTION

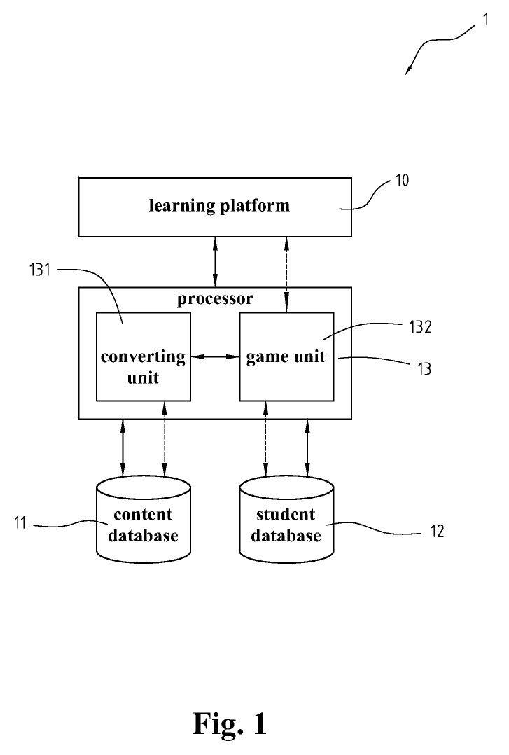

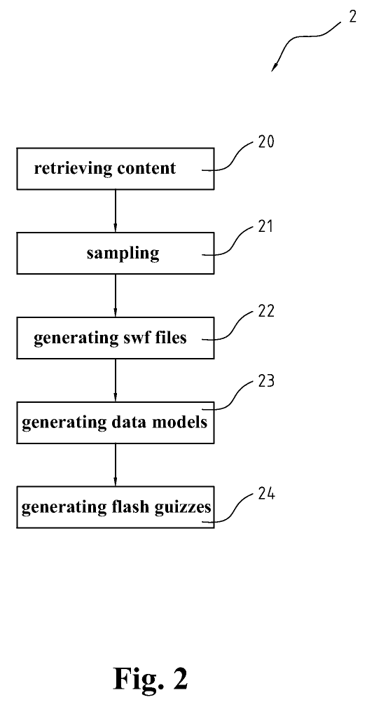

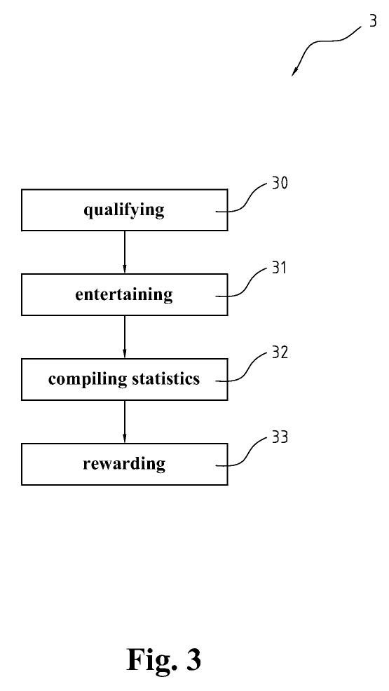

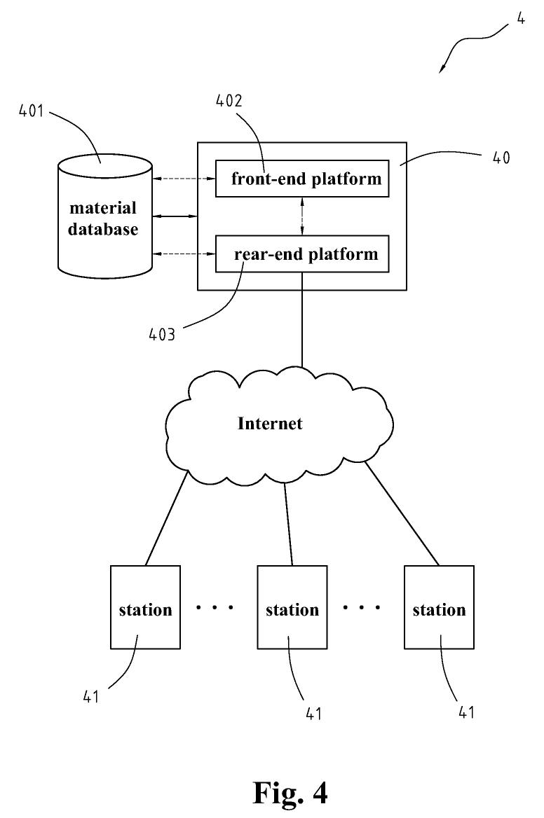

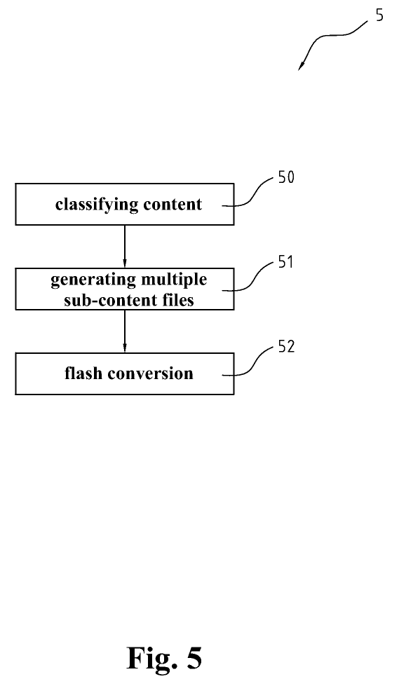

With reference to FIGS. 1-5, a computerized education device (1) in accordance with the present invention uses a multimedia production device (4) in accordance with the present invention to generate multimedia content using associated methods (2, 3, 5) in accordance with the present invention.

The computerized education device (1) comprises a learning platform (10), a content database (11), a student database (12) and a processor (13).

The learning platform (10) is a graphical user interface (GUI) and an optional web-based interface. The GUI offers graphical indicators to a person and allows the person to interact with the education device and take tests. The web-based interface may allow a person to log into the computerized education device (1) through a computer connected to the internet.

The content database (11) comprises multiple records, multiple exercises and multiple game modules. The exercises are stored respectively in records in at least one file format. The at least one file format may be selected from Word, text, numerical, date or data files. The game modules are respectively Flash backgrounds and comprise interactivity and sound effects.

The student database (12) stores personal information data about specific students. The personal information data for each student comprises at least the student's name, account name, password, grade and academic history.

The content database (11) and student database (12) may be a Relational Database Model database.

The processor (13) generates a FLASH quiz, is connected to the learning platform (10), the content database (11) and the student database (12), sends the corresponding FLASH quiz to the learning platform (10) and comprises a converting unit (131) and a game unit (132).

The converting unit (131) is connected to the content database (11), converts content of the exercise into a FLASH component and generates the FLASH quiz.

The game unit (132) is connected to the converting unit (131), the learning platform (10) and the student database (12) and provides entertainment interaction through the learning platform (10).

A Flash component conversion method (2) in accordance with the present invention may be performed in the converting unit (131), converts content of an exercise into a FLASH component, generates a FLASH quiz and comprises acts of retrieving content (20), sampling (21), generating small web format (swf) files (22), generating data models (23) and generating FLASH quizzes (24). The FLASH quizzes are sent to the learning platform (10) by the processor (13).

The act of retrieving content (20) comprises retrieving content of an exercise and a corresponding game module from the content database (11).

The act of sampling (21) comprises converting the content of the exercise to a uniform image format (such as Windows Metafile (WMF) or Joint Photographic Experts Group (JPEG) format) and generates a temporary image file.

The act of generating swf files (22) comprises animating FLASH components based on the temporary image files and may apply OPENOFFICE DRAW.

The act of generating data models (23) converts the swf files to an Extensible Markup Language (XML) files. The XML files comprise information including display locations, size ratios between temporary image files and desired display sizes and links to the FLASH component.

An example of the XML in accordance with the present invention follows:

```
  <?xml version= “1.0” encoding= “iso-8859-1” ?>
  <background color= “#ffffff” />
  <frame>
    <library>
      <clip id= “new” import= “The link of the FLASH component”>
    </library>
    <place id= “new” x= “a” y= “b” scale= “desired displaying
size/temporary image file” />
  </frame>.
```

The act of generating a FLASH quizzes (24) generates a FLASH quiz based on ActionScript language and uses SWFMILL application software to combine the FLASH component and the game module with a specific scale.

The SWFMILL application software is open source software and its operational method is disclosed at http://swfmill.org.

An interacting method (3) in accordance with the present invention is used in a computerized education device (1) comprising a learning platform (10), a content database (11), a student database (12) and a processor (13), may be used in the game unit (132) and comprises acts of qualifying (30), entertaining (31), compiling statistics (32) and an optional rewarding (33).

The act of qualifying (30) comprises generating a game script, determines difficulty of the game script based on a person's academic history and requests that the converting unit (131) retrieve corresponding exercises to generate multiple corresponding FLASH questions based on the difficulty of the game script.

The act of entertaining (31) comprises transmitting a corresponding FLASH question to the person based on previous responses of the person and the game script.

The act of compiling statistics (32) comprises recording whether the response to a question is correct or incorrect and stores the result in the student database (12).

The act of rewarding (33) comprises giving each person reward points based on the response of questions and stores the reward points in the student database (12).

The reward points can be used as virtual credit allows a person to exchange or purchase virtual goods through some web applications on the education device (1). The applications may be a Flash based virtual character that allows the person buying most novel and fashion clothes for the virtual character, which encourage the person to take tests to earning as much reward points as possible.

Since the difficulty of a game script and the generation of the FLASH question are determined dynamically based on the person's academic performance, the computerized education device (1) provides a challenging and adaptive learning environment that promotes a person's motivation in learning.

A multimedia production device (4) in accordance with the present invention has multiple-user and multiple-tasking capabilities to produce multimedia materials and comprises a managing server (40) and multiple stations (41).

The managing server (40) monitors production procedures and relations of materials, traces errors and comprises a material database (401), a front-end platform (402), a rear-end platform (403) and an optional content decomposing method (5).

The material database (401) stores multimedia materials and links to corresponding materials.

The multimedia materials may be music, sounds, images including photos and questions.

The front-end platform (402) is connected to the material database (401), collects error information, may connect to a computerized education device (1) having a learning platform (10), a content database (11), a student database (12) and a processor (13) and retrieves and sends finished multimedia materials (exercises or game modules) to the computerized education device (1).

The rear-end platform (403) is connected to the material database (401) and the front-end platform (402), is an editing platform for a person to obtain desired material for making multimedia materials and feeds back finished work (or semi finished material) to the material database (401).

The stations (41) are connected to the rear-end platform (403) through the internet that allows specialists such as an animation designer, a teacher, a content editor, a testing member, a FLASH animator or a programmer to cooperate with other specialists.

However, the multimedia materials stored in the material database (401), especially to the quiz content widely vary in different fields such as mathematics to history. Therefore, the content decomposing method (5) in accordance with the present invention is imbedded in the used to help specialists to separate quiz content without having to understand the specific quiz content and comprises acts of classifying content (50), generating multiple sub-content files (51) and an optional FLASH conversion (52).

The act of classifying content (50) retrieves the quiz content from the material database (401) and classifies the quiz content into multiple divisions. The divisions can be tables of a WORD document or be divided by labels (i.e. <title></title>,) and the divisions comprise type, title, description, sources, answers and answer options.

The act of generating multiple sub-content files (51) divides multiple divisions into multiple sub-content files and stores the sub-content files in the material database (401).

The optional act of FLASH conversion (52) uses the Flash component conversion method if the specialist is a FLASH producer that requires making a FLASH quiz, converts the sub-content files to a FLASH component and stores the FLASH component in the material database.

People skilled in the art will understand that various changes, modifications, and alterations in form and details may be made without departing from the spirit and scope of the invention.

What is claimed is:

1. A computerized education device comprising
a learning platform being a graphical user interface offering graphical indicators to a person and allowing the person to interact with the education device and take tests;
a content database comprising
multiple records;
multiple exercises being stored respectively in records; and
multiple game modules being respectively Flash backgrounds and comprising interactivity and sound effects;
a student database storing personal information data about specific students, and the personal information data for each student comprising at least the student's name, account name, password, grade and academic history; and
a processor generating a FLASH quiz, being connected to the learning platform, the content database and the student database, sending the corresponding FLASH quiz to the learning platform and comprising
a converting unit being connected to the content database, converting content of the exercise into a FLASH component and generating the FLASH quiz; and
a game unit being connected to the converting unit, the learning platform and the student database and providing entertainment interaction through the learning platform.

2. The computerized education device as claimed in claim 1, wherein the learning platform is further a web-based interface allowing a person to log into the computerized education device through a computer connected to the internet.

3. The computerized education device as claimed in claim 1, wherein the records holding the exercises are in at least one file format selected from a group consisting of Word file text files, numerical, date and data files.

4. The computerized education device as claimed in claim 1, wherein the game unit further comprising an interacting method, the interacting method comprises acts of
qualifying comprising generating a game script, determining difficulty of the game script based on a person's academic history and requests that the converting unit retrieve corresponding exercises to generate multiple corresponding FLASH questions based on the difficulty of the game script;
entertaining comprising transmitting a corresponding FLASH question to the person based on the previous responses of the person and the game script; and
compiling statistics comprising recording whether the response to a question is correct or incorrect and storing the result in the student database.

5. The computerized education device as claimed in claim 4, wherein interacting method further comprising act of
rewarding comprises giving each person reward points based on the response of questions and stores the reward points in the student database.

6. A Flash component conversion method converting content of an exercise in a computerized education device comprising a learning platform, a content database, a student database and a processor into a Flash component and generating a FLASH quiz, and the Flash component conversion method comprising acts of
retrieving content comprises retrieving content of an exercise and a corresponding game module from the content database;
sampling comprises converting the content of the exercise to a uniform image format and generating a temporary image file;
generating swf files comprising animating FLASH components based on the temporary image file;
generating data models comprises converting the swf file to an Extensible Markup Language (XML) file comprising information including display locations, size ratio between the temporary image file and desired display size and a link of the FLASH component; and
generating FLASH quizzes comprises generating FLASH quizzes based on ActionScript language and using SWFMILL application software to combine the FLASH component and the game module with a specific scale and being sent to a learning platform by the processor.

7. The method as claimed in claim 6, wherein the act of generating swf files animates FLASH components applies OPENOFFICE DRAW.

8. A multimedia production device having multiple-user and multiple-tasking capabilities to produce multimedia materials and comprising
a managing server monitoring production procedures and relations of materials, tracing errors and comprising
a material database stores multiple multimedia materials and links to corresponding materials;
a front-end platform being connected to the material database and collecting error information; and
a rear-end platform being connected to the material database and the front-end platform, being an editing platform for a person to obtain desired material for making multimedia material and feeding back finished work to the material database; and
multiple stations being connected to the rear-end platform through a network allows specialists to cooperate with other specialists.

9. The multimedia production device as claimed in claim 8, wherein the front-end platform is connected to a computerized education device having a learning platform, a content database, a student database and a processor.

10. The multimedia production device as claimed in claim 8, wherein the multimedia materials respectively comprise music, sounds, images including photos and questions.

11. The multimedia production device as claimed in claim 8 further comprising a content decomposing method comprises acts of
classifying content comprising retrieving the quiz content from the material database and classifying the quiz content into multiple divisions; and
generating multiple sub-content files comprising dividing multiple divisions into multiple sub-content files and storing the sub-content files in the material database.

12. The multimedia production device as claimed in claim 11, wherein the divisions of the content decomposing method are tables of a WORD document.

13. The multimedia production device as claimed in claim 11, wherein the divisions of the content decomposing method are divided by labels.

14. The multimedia production device as claimed in claim 11, wherein The content decomposing method further comprising an act of FLASH conversion comprising converting the sub-content files to FLASH components and storing the FLASH components in the material database.

15. The computerized education device as claimed in claim 1, wherein the content database being a Relational Database Model database.

16. The computerized education device as claimed in claim 1, wherein the student database being a Relational Database Model database.
